(19) United States
(12) Patent Application Publication
(10) Pub. No.: US 2008/0187422 A1
(43) Pub. Date: Aug. 7, 2008

(54) TRANSPORTING PLATFORM AND TRANSPORTING MODULE

(76) Inventors: Xiong Zhao, Nantong (CN); Xiaohui Ni, Nantong (CN); Weijia Guo, Nantong (CN); Yao Chen, Nantong (CN)

Correspondence Address: GREER, BURNS & CRAIN, 300 S WACKER DR, 25TH FLOOR, CHICAGO, IL, 60606, US

(21) Appl. No.: 12/025,507

(22) Filed: Feb. 4, 2008

(30) Foreign Application Priority Data
Feb. 5, 2007 (CN) 200710063587.0

(51) Int. Cl. B65G 1/14

(52) U.S. Cl. 414/267

(57) ABSTRACT

A transporting platform and a transporting module composed of plurality of transporting platforms, for stacking non-standard containers on standard containers or standardized transporting equipment. The transporting platform includes a pair of transverse beams and a pair of longitudinal beams arranged between the transverse beams. Each of the transverse beams includes: at least one top fitting, arranged on the upper part of the transverse beam for fitting the bottom corner fitting of the non-standard container; and a pair of bottom corner fittings, arranged on the lower part of the transverse beam, and having a center distance therebetween corresponding to the center distance between the corner fittings along the width direction of the standard container.

### FIELD OF THE INVENTION

The present invention relates to a logistics apparatus for stacking and positioning, particularly to a transporting platform and a transporting module for stacking and positioning non-standard container.

### BACKGROUND OF THE INVENTION

Generally, a container is provided with four top corner fittings at its top corners, as well as four bottom corner fittings at its bottom corners. During transportation, the container can be stacked and positioned on a ship or a special transporting vehicle through said corner fittings.

For a standard container, such as an ISO container, the distance between two adjacent corner fittings is standardized. For example, for a 40' ISO container, the center distance between adjacent corner fittings along width direction is about 2259 mm, while the center distance between adjacent corner fittings along the length direction is about 11985 mm. Therefore, containers from different manufacturers can be stacked and positioned with each other or on standardized transporting equipment.

For a non-standard container, however, the distance between adjacent corner fittings is generally not up to the common standard requirement, which will bring problems in its transportation. For example, as shown in FIG. 1, when non-standard containers 10 are transported with standardized container transporting equipment 1, they have to be arranged at intervals along their width directions, each of which occupies more than one berth 45, causing a waste in berths. In addition, during such arrangement, it is always difficult to position accurately between the corner fittings 11 of the non-standard container and the corner fittings 4 of the transporting equipment, so that the transportation safety is reduced. When other transporting equipments, such as bulk-cargo ships, are used to transport the non-standard containers in bulk-cargo way, it is always necessary to perform modifications to such transporting equipments, causing thus an increase in transportation costs.

### SUMMARY OF THE INVENTION

It is the objective of the present invention to provide a transporting platform for stacking non-standard containers on standard containers or standardized transporting equipment.

It is another objective of the present invention to provide a transporting module, by means of which non-standard containers can be closely placed and side by side stacked.

According to one aspect of the invention, a transporting platform for stacking non-standard containers on standard containers or standardized transporting equipment is provided. Said transporting platform comprises a pair of transverse beams and a pair of longitudinal beams arranged between the transverse beams. Each of the transverse beams comprises: at least one top fitting, arranged on the upper part of the transverse beam for fitting the bottom corner fitting of the non-standard container; and a pair of bottom corner fittings, arranged on the lower part of the transverse beam, and having a center distance therebetween corresponding to the center distance between the corner fittings along the width direction of the standard container.

Preferably, the transverse beam has a length corresponding to the width of the standard container, while the longitudinal beam has a length corresponding to the length of the standard container.

Preferably, two top fittings are arranged on the upper part of each transverse beam, which are separated by a predetermined center distance.

Preferably, wherein three top fittings are arranged on the upper part of each transverse beam, two of which are arranged at two ends of the transverse beam respectively.

Preferably, the other top fitting, which is arranged in the middle portion of the transverse beam, keeps a predetermine center distance to one of the top fittings arranged at the ends of the same transverse beam.

Preferably, four top fittings are arranged on the upper part of each transverse beam, two of which are arranged at two ends of the transverse beam respectively. The other two top fittings are separated by a predetermine center distance.

Preferably, the corresponding bottom corner fittings arranged respectively on the pair of transverse beams are aligned with each other, while the corresponding top fittings arranged respectively on the pair of transverse beams are aligned with each other.

The transporting platform further comprises one or more reinforcing members arranged between the transverse beams and/or the longitudinal beams.

According to another aspect of the invention, a transporting module is provided for stacking non-standard containers on standard containers or on standardized container transporting equipment. Said transporting module comprises a plurality of transporting platforms, each platform including a pair of transverse beams and a pair of longitudinal beams arranged between the transverse beams respectively. Each transverse beam comprises: at least one top fitting, arranged on the upper part of the transverse beam for fitting the bottom corner fitting of the non-standard container; and a pair of bottom corner fittings, arranged on the lower part of the transverse beam, and having a center distance therebetween corresponding to the center distance between the corner fittings along the width direction of the standard container. When in working state, the at least one top fitting on one transporting platform is separated from the at least one top fitting on the adjacent transporting platform by a center distance corresponding to the center distance between the corner fittings along width direction of the non-standard container.

Preferably, the transverse beam has a length corresponding to the width of the standard container, while the longitudinal beam has a length corresponding to the length of the standard containers.

Said plurality of transporting platforms includes a first transporting platform provided with three top fittings on each transverse beam, wherein two top fittings are arranged at two ends of the transverse beam respectively while the other one is arranged in the middle portion of the transverse beam.

Said plurality of transporting platforms includes a second transporting platform provided with three top fittings on each transverse beam, wherein two top fittings are arranged at two ends of the transverse beam respectively while the other one is arranged in the middle portion of the transverse beam. The top fitting arranged in the middle portion is spaced apart from one of the top corner fittings arranged at the ends by a predefined center distance.

The first transporting platform is adjacent to the second transporting platform when in working state, one of the top fittings arranged at the ends of the transverse beam of the second transporting platform is spaced apart from the top fitting arranged in the middle portion of the corresponding transverse beam of the first transporting platform by a center distance corresponding to the center distance between the corner fittings along the width direction of the non-standard container.

Said plurality of transporting platforms includes a third transporting platform provided with four top fittings on each transverse beam, wherein two top fittings are arranged at two ends of the transverse beam respectively, while the other two are arranged in the middle portion of the transverse beam and keep a predefined center distance therebetween.

The second transporting platform is adjacent to the third transporting platform when in working state, the top fitting arranged in the middle portion of the transverse beam of the second transporting platform is spaced apart from one of the top fittings arranged in the middle portion of the corresponding transverse beam of the third transporting platform by a distance corresponding to the center distance of the corner fittings along the width direction of the non-standard container.

The transporting platform according to the invention is simple in structure, easy to manufacture and convenient to use. By means of the transporting platform and/or the transporting module according to the invention, non-standard containers can be conveniently stacked on standard containers or standardized transporting equipment, so that non-standard containers can be arranged closely to each other like standard ones. The usability of stacking space can be efficiently raised, reducing thus the costs of storage and transportation. Moreover, the transporting module of the present invention is convenient for storage. In particularly, when not in use, the transporting module can be divided into several transporting platforms that can be stacked with each other as well as stacked with standard containers. Therefore, there is no waste in berth.

### BRIEF DESCRIPTION OF THE DRAWINGS

Reference will now be made in detail to embodiments of the present invention, examples of which are illustrated in the accompanying drawings, wherein:

FIG. 1 is a schematic drawing showing non-standard containers stacked on standardized container transporting equipment according to the prior art;

FIG. 2A˜2C are the top view, side view and left view of an embodiment of the transporting platform according to the present invention, respectively;

FIG. 3 is a schematic drawing showing another embodiment of the transporting platform according to the present invention;

FIG. 4A is a schematic drawing showing a plurality of non-standard containers stacked side by side by means of the transporting platforms according to the invention;

FIG. 4B is a side view of FIG. 4A;

FIG. 5 is a partial sectional view of FIG. 4A without the standard containers;

FIG. 6 is a schematic drawing showing the stacking between the transporting platform according to the invention and the standard containers; and

FIG. 7 is a schematic drawing showing a plurality of transporting platforms stacked with each other.

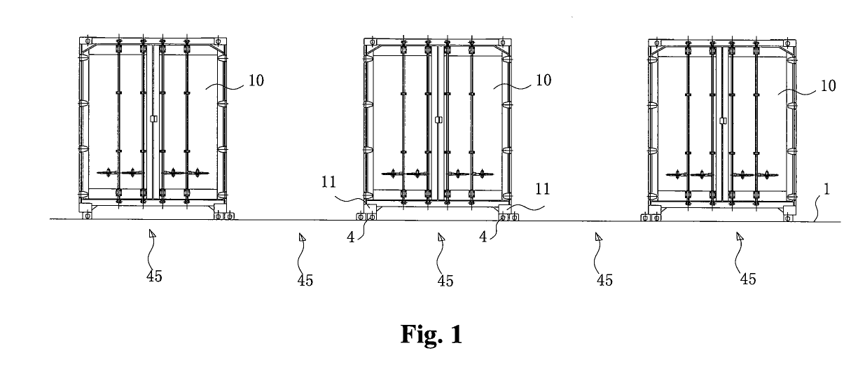

### DETAILED DESCRIPTION OF THE PREFERRED EMBODIMENT

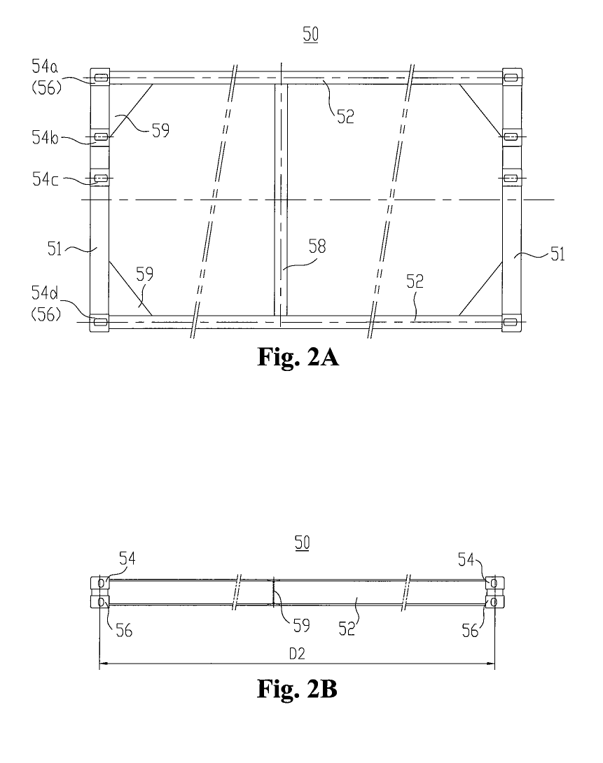

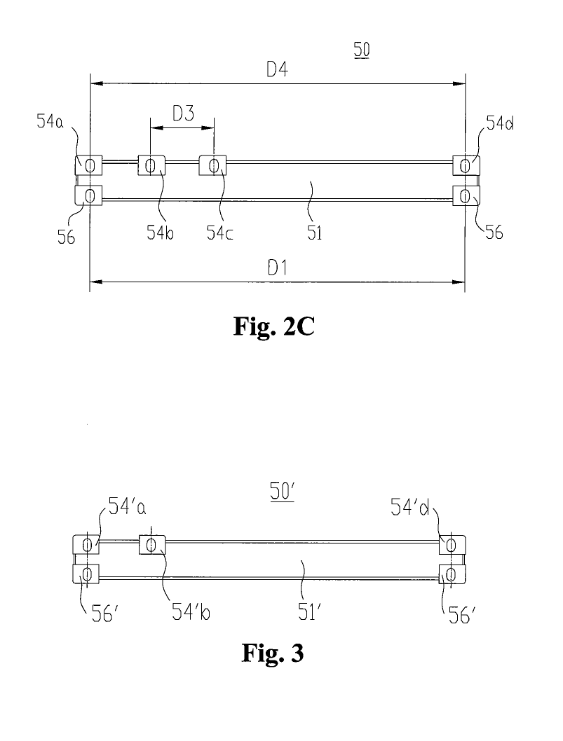

FIGS. 2A to 2C show a transporting platform 50 according to one embodiment of the present invention. As shown in FIGS. 2A to 2C, the transporting platform 50 includes a pair of transverse beams 51 and a pair of longitudinal beams 52 arranged between said transverse beams 51. Said transverse beams 51 and longitudinal beams 52 constitute a frame body of the transporting platform 50. One or more reinforcing members can be preferably arranged in the frame body, in order to raise the overall strength of the transporting platform 50. For example, reinforcing plates 59 can be arranged in the included angles of the adjacent transverse and longitudinal beams 51 and 52, while a reinforcing beam 58 can be arranged between the opposite longitudinal beams 52. Other reinforcing structure can be also arranged to the platform 50, such as beams between the opposite transverse beams 52.

Each transverse beam 51 is provided with a pair of bottom corner fittings 56 on its lower part, which are separated by a center distance D1 (see FIG. 2C) corresponding to the center distance between the corner fittings along the width direction of the ISO container. The corresponding bottom corner fittings 56 arranged on two opposite transverse beams 51 are preferably aligned with each other and spaced apart by a center distance D2 (see FIG. 2B) corresponding to the center distance between the corner fittings along length direction of the ISO container. Thus, the transporting platform 50 can be stacked on the ISO container through connecting its bottom corner fittings 56 to corresponding top corner fittings of the ISO container. Of course, the transporting platform 50 can be also stacked on the deck of a standardized container ship through connecting its bottom corner fittings 56 to corresponding corner fittings of the berth on the deck. Preferably, the lengths of each transverse beam 51 and each longitudinal beam 52 are suitably set to fit the width and the length of ISO container respectively, so that the transporting platform 50 can be generally aligned with the ISO container when stacked thereon.

Each transverse beam 51 is further provided with at least one top fitting (such as the top fitting 54b for example) on its upper part, for fitting the bottom corner fitting of the non-standard container. The corresponding top fittings 54 arranged on the opposite transverse beams 51 are preferably aligned with each other. By providing plurality of transporting platforms 50 and properly setting the position of their top fittings, non-standard containers can be accurately positioned and securely fixed on the platforms 50 by connecting the bottom corner fittings of the non-standard containers to the corresponding top fittings 54 of the platforms 50. Since the platforms 50 can be fixed on the berths for ISO containers, the non-standard container can be securely stacked by using the standardized berths. Preferably, the top fitting 54 for fitting the bottom corner fitting of the non-standard container is embedded into the transverse beam 51 so as to increase the shock-resistant ability.

To save the space for stacking, non-standard containers are desirably stacked side by side, with the adjacent containers being placed as closely as possible. Preferably, two top fittings, such as 54b and 54c, are provided on each transverse beam 51 of the platform 50, for fitting two adjacent bottom corner fittings arranged respectively on two adjacent non-standard containers. The top fittings 54b and 54c are separated by a predefined center distance D3 related to the spacing distance between two adjacent non-standard containers. In particularly, the distance D3 corresponds to the center distance between two adjacent bottom corner fittings arranged respectively on two adjacent non-standard containers. Therefore, the non-standard containers can be stacked side by side and keep a desirable distance between each other.

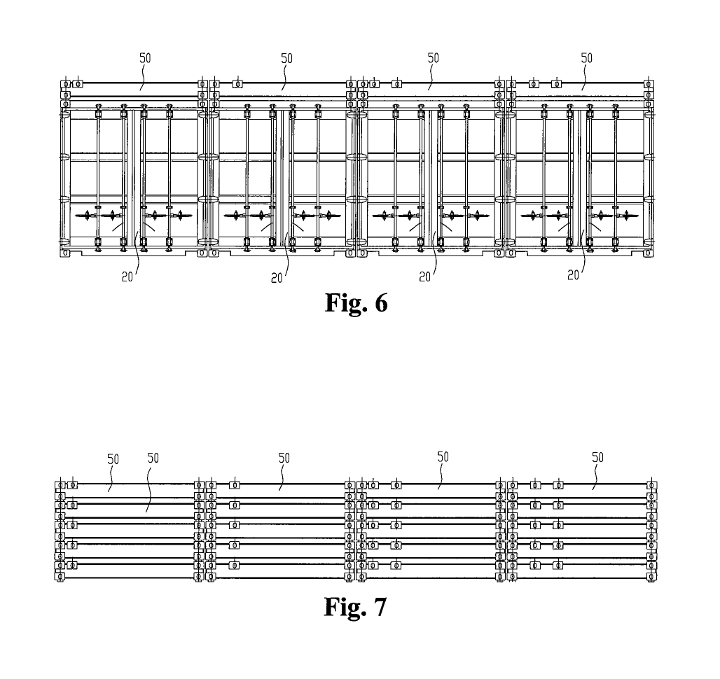

Preferably, each transverse beam 51 can be provided with another pair of top fittings, such as 54a and 54d, at its two ends. The top fitting arranged at the end of the transverse beam 51 is usually referred as top corner fitting. Preferably, the top corner fittings 54a and 54d are aligned with the pair of bottom corner fittings 56 on the same transverse beam 51 respectively. Thus, the center distance D4 between the top corner fittings 54a and 54d is also corresponding to the center distance between the corner fittings along width direction of the ISO container. With the top corner fittings 54a, 54d and the bottom corner fittings 56, the transporting platform 50 and the ISO container 20 can be stacked with each other (see FIG. 6), while plurality of transporting platforms 50 themselves can also be stacked with each other (see FIG. 7). The top fittings (such as 54b and/or 54c) for fitting the bottom corner fittings of the non-standard container are generally disposed between the pair of top corner fittings (such as 54a and 54d).

FIG. 3 shows a transporting platform 50′ according to another embodiment of the present invention. As shown in FIG. 3, each transverse beam 51′ of the platform 50′ is provided with three top fittings 54′a, 54′b and 54′d. The top corner fittings 54′a and 54′d are disposed at the ends of the transverse beam 51′ respectively, and spaced apart from each other by a center distances corresponding to center distances between the corner fittings along the width direction of the ISO container. Top corner fittings 54′a and 54′d are preferably aligned with two bottom corner fittings 56′ on the same transverse beam. The other top fitting 54′b is disposed in the middle portion of the transverse beam 51′ and spaced apart from the top corner fitting 54′a by a predefined center distance corresponding to the center distance between the two adjacent bottom corner fittings arranged respectively on two adjacent non-standard containers. By suitably disposing the top fitting 54′b, the adjacent non-standard containers can keep a desirable spacing distance. In such arrangement, the top corner fitting 54′a can cooperate with the top corner fitting 54′d for stacking the platform 50′ with another platform or with the ISO container, alternatively the top corner fitting 54′a can cooperate with the top fitting 54′b for closely stacking non-standard containers.

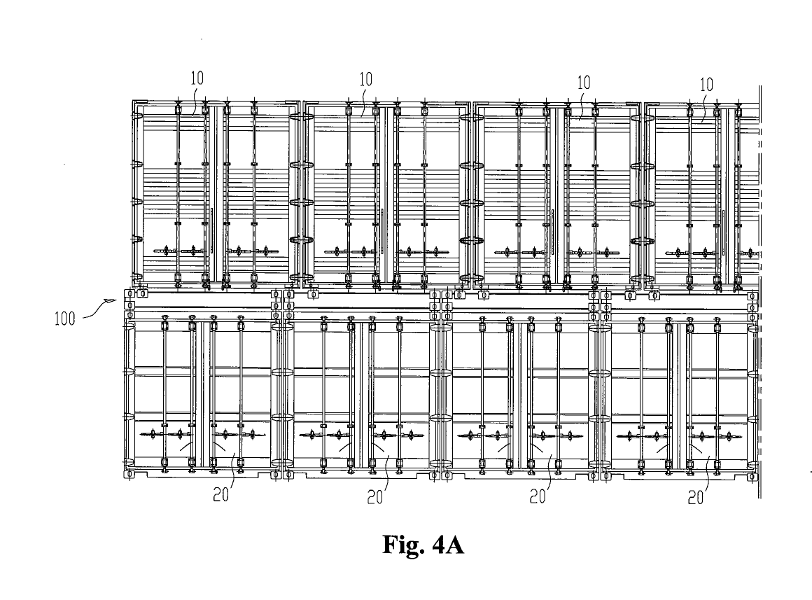

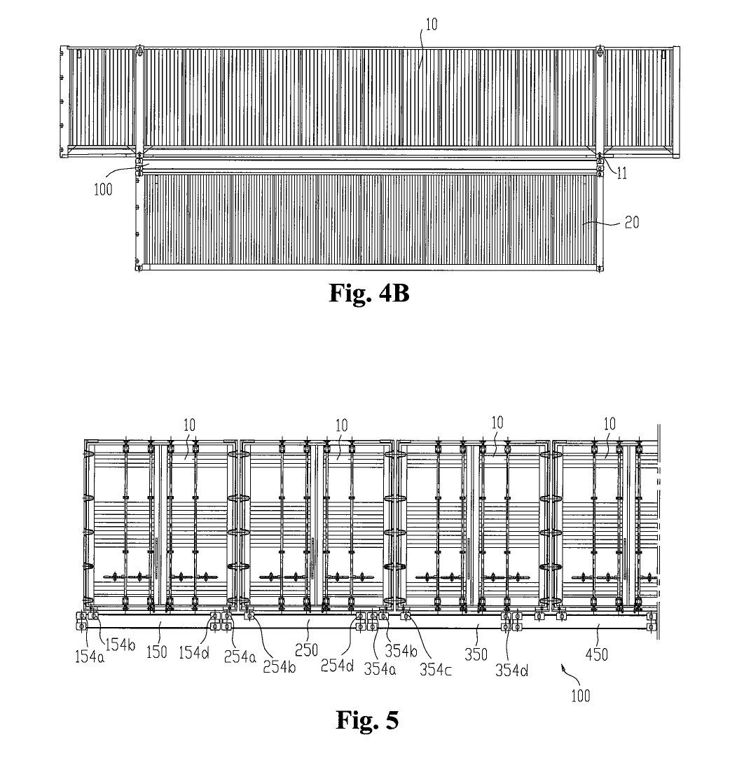

As shown in FIG. 4A, a plurality of transporting platforms are arranged in a line and forming a transporting module 100, through which side-by-side non-standard containers 10 can be stacked on side by side ISO standard containers 20, wherein the non-standard containers can be arranged closely so as to save the space. Here, each platform 50 of the module 100 is placed on one standard container 20. It should be appreciated that, in other embodiment of the invention, the platform 50 can be arranged directly on a deck or other suitable location for stacking non-standard containers.

As shown in FIG. 4B, for the non-standard container 10 with its length longer than the standard one, top fittings of the transporting module 100 can be connected to the bottom corner fittings 11 or the bottom connecting holes (not shown) arranged in the middle portion of the bottom of the non-standard container 10.

Preferably, the position of each top fitting for fitting the bottom corner fitting of the non-standard container 10 is properly set, so that the center distance between two adjacent top corner fittings arranged respectively on adjacent transporting platforms is corresponding to the desirable center distance of the bottom corner fittings of the non-standard containers 10. Therefore, the non-standard container 10 can be stacked over different transporting platforms. Meanwhile, with respect to one or more transporting platforms, two top fittings for stacking non-standard containers can be arranged on each transverse beam, wherein, the center distance of said two top fittings is set related to the space distance between the adjacent non-standard containers.

As shown in FIG. 5, the transporting module 100 according to one embodiment of the invention includes a plurality of transporting platforms, such as 150, 250, 350 and 450. Three top fittings 154a, 154b and 154d are arranged on each transverse beam of the transporting platform 150, wherein two of them, i.e., 154a and 154d, are arranged at the ends of the transverse beam while the other one 154b is arranged in the middle portion of the transverse beam. Three top fittings 254a, 254b and 254d are arranged on each transverse beam of the transporting platform 250, wherein two of them, i.e., 254a and 254d, are arranged at the ends of the transverse beam while the other one 254b is arranged in the middle portion of the transverse beam. Four top fittings 354a, 354b, 354c and 154d are arranged on each transverse beam of the transporting platform 350, wherein two of them, i.e., 354a and 354d, are arranged at the ends of the transverse beam while the other two, i.e., 354b and 354c are arranged in the middle portion of the transverse beam and separated by a predefine center distance for keeping a predefined space between the adjacent non-standard containers. The arrangement of the top fittings on the transporting platform 450 is similar to that of the transporting platform 350. The number of the platforms in one transporting module as well as the arrangement of the top fittings of each platform can be varies according to the number and the sizes of the non-standard containers to be stacked thereon. It should be understood that, by suitably positioning of the top fittings of the transporting module, containers having different sizes can be stacked side by side.

When the transporting module 10 is in wording state as shown in FIG. 5, the center distance between the top fitting 154b of the transporting platform 150 and the top fitting 254a of the transporting platform 250 can be arranged corresponding to the center distance of the corner fittings along the width direction of non-standard container. The center distance of the top fitting 254b of the transporting platform 250 and the top fitting 354b of the third transporting platform 350 can be also arranged corresponding to the center distance between the corner fittings along the width direction of non-standard containers.

When the transporting module 100 is not in use, the plurality platforms can be stacked with each other by means of the top and bottom corner fittings arranged at the ends of the transverse beams of each platform. As shown in FIG. 6, each of the transporting platforms 50 can be stacked on one standard container 20. Preferably, each transporting platform 50 is sized and configured correspondingly to the size of the standard container. Thus, after the stacking, the transporting platform 50 can be substantially aligned with the standardized container 20. As shown in FIG. 7, plurality of transporting platforms 50 can also be stacked with each other. Standard containers can be further stacked on the stacked transporting platform. Thus the stacking space can be full utilized.

Although several preferred embodiments of the present invention have been described, the present invention may be used with other configurations. It will be appreciated by those skilled in the art that, the present invention could have many other embodiments, and changes and modifications may be made thereto without departing from the invention in its broader aspects and as set forth in the following claims and equivalents thereof.

What is claimed is:

1. A transporting platform, for stacking non-standard containers on standard containers or on standardized container transporting equipment, comprising a pair of transverse beams, and a pair of longitudinal beams arranged between the transverse beams, wherein each of the transverse beams comprises:
at least one top fitting, arranged on the upper part of the transverse beam for fitting the bottom corner fitting of the non-standard container; and
a pair of bottom corner fittings, arranged on the lower part of the transverse beam, and having a center distance therebetween corresponding to the center distance between the corner fittings along the width direction of the standard container.

2. The transporting platform according to claim 1, wherein the transverse beam has a length corresponding to the width of the standard container, while the longitudinal beam has a length corresponding to the length of the standard container.

3. The transporting platform according to claim 1, wherein two top fittings are arranged on the upper part of each transverse beam, which are separated by a predetermined center distance.

4. The transporting platform according to claim 1, wherein three top fittings are arranged on the upper part of each transverse beam, two of which are arranged at two ends of the transverse beam respectively.

5. The transporting platform according to claim 4, wherein the other top fitting, which is arranged in the middle portion of the transverse beam, keeps a predetermine center distance to one of the top fittings arranged at the ends of the same transverse beam.

6. The transporting platform according to claim 1, wherein four top fittings are arranged on the upper part of each transverse beam, two of which are arranged at two ends of the transverse beam respectively.

7. The transporting platform according to claim 6, wherein the other two top fittings are separated by a predetermine center distance.

8. The transporting platform according to claim 1, wherein the corresponding bottom corner fittings arranged respectively on the pair of transverse beams are aligned with each other, while the corresponding top fittings arranged respectively on the pair of transverse beams are aligned with each other.

9. The transporting platform according to claim 1, further comprising one or more reinforcing members arranged between the transverse beams and/or the longitudinal beams.

10. A transporting module for stacking non-standard containers on standard containers or on standardized container transporting equipment, comprising a plurality of transporting platforms, each transporting platform including a pair of transverse beams and a pair of longitudinal beams arranged between the transverse beams respectively,
wherein, each transverse beam comprises
at least one top fitting, arranged on the upper part of the transverse beam for fitting the bottom corner fitting of the non-standard container; and
a pair of bottom corner fittings, arranged on the lower part of the transverse beam, and having a center distance therebetween corresponding to the center distance between the corner fittings along the width direction of the standard container,
wherein, when in working state, the at least one top fitting on one transporting platform is separated from the at least one top fitting on the adjacent transporting platform by a center distance corresponding to the center distance between the corner fittings along width direction of the non-standard container.

11. The transporting module according to claim 10, wherein the transverse beam has a length corresponding to the width of the standard container, while the longitudinal beam has a length corresponding to the length of the standard containers.

12. The transporting module according to claim 10, wherein said plurality of transporting platforms includes a first transporting platform provided with three top fittings on each transverse beam, wherein two top fittings are arranged at two ends of the transverse beam respectively while the other one is arranged in the middle portion of the transverse beam.

13. The transporting module according to claim 12, wherein said plurality of transporting platforms includes a second transporting platform provided with three top fittings on each transverse beam, wherein two top fittings are arranged at two ends of the transverse beam respectively while the other one is arranged in the middle portion of the transverse beam,
wherein, the top fitting arranged in the middle portion is spaced apart from one of the top corner fittings arranged at the ends by a predefined center distance.

14. The transporting module according to claim 13, wherein the first transporting platform is adjacent to the second transporting platform when in working state, one of the top fittings arranged at the ends of the transverse beam of the second transporting platform is spaced apart from the top fitting arranged in the middle portion of the corresponding transverse beam of the first transporting platform by a center distance corresponding to the center distance between the corner fittings along the width direction of the non-standard container.

15. The transporting module according to claim 13, wherein said plurality of transporting platforms includes a third transporting platform provided with four top fittings on each transverse beam, wherein two top fittings are arranged at two ends of the transverse beam respectively, while the other two are arranged in the middle portion of the transverse beam and keep a predefined center distance therebetween.

16. The transporting module according to claim 15, wherein the second transporting platform is adjacent to the third transporting platform when in working state, the top fitting arranged in the middle portion of the transverse beam of the second transporting platform is spaced apart from one of the top fittings arranged in the middle portion of the corresponding transverse beam of the third transporting platform by a distance corresponding to the center distance of the corner fittings along the width direction of the non-standard container.
